(19) United States
(12) Patent Application Publication
(10) Pub. No.: US 2015/0258753 A1
(43) Pub. Date: Sep. 17, 2015

(54) MULTILAYER LAMINATE FOR TIRES

(71) Applicants: COMPAGNIE GENERAL DES ETABLISSEMENTS MICHELIN, CLERMONT-FERRAND (FR); Michelin Recherche et Technique S.A., GRANGES-PACCOT (CH)

(72) Inventors: Emmanuel Custodero, Clermont-Ferrand (FR); Marc Greiveldinger, Clermont-Ferrand (FR); Catherine Gauthier, Clermont-Ferrand (FR)

(21) Appl. No.: 14/418,323

(22) PCT Filed: Jul. 24, 2013
(86) PCT No.: PCT/EP2013/065635

§ 371 Date: Jan. 29, 2015

(30) Foreign Application Priority Data
Jul. 30, 2012 (FR) 1257366

(51) Int. Cl. B32B 25/14; B32B 27/08; B32B 27/40; B32B 27/32; B32B 27/34; B60C 1/00; B32B 25/16

(52) U.S. Cl. CPC B32B 25/14; B60C 1/0041; B32B 27/08; B32B 25/16; B32B 27/32; B32B 27/34; B32B 27/40; B32B 2270/00; B32B 2605/00

(57) ABSTRACT

An elastomeric laminate for tires comprises at least two superimposed layers of elastomer. The first layer is composed of a composition based on at least one thermoplastic elastomer, the content of thermoplastic elastomer being within a range extending from more than 50 to 100 phr. The second layer is composed of a composition based on at least one diene elastomer, the content of diene elastomer being within a range extending from more than 50 to 95 phr, and on at least one thermoplastic elastomer, the content of thermoplastic elastomer being within a range extending from 5 to less than 50 phr. At least 5 phr of the thermoplastic elastomers present in the second layer are compatible with at least 5 phr of the elastomers present in the first layer.

The present invention relates to laminates for tyres comprising a composition, the elastomers of which are predominantly thermoplastic elastomers (TPEs), in one of their elastomeric layers.

In a conventional tyre, the various elastomeric layers are composed of diene elastomer compositions, adhering to one another via bonds created during the crosslinking of the said elastomers. These layers thus have to be combined before the curing (or the crosslinking) in order to allow them to adhere.

It is advantageous today for tyre manufacturers to use elastomeric layers comprising, as elastomers, predominantly thermoplastic elastomers (TPEs) in order to benefit from the properties of these elastomers, in particular for the reduction in the rolling resistance and the processability.

The difficulty in the use of such layers, the elastomers of which are predominantly TPEs, is their adhesion to the adjacent diene layers of conventional composition before the curing of the resulting laminate or after the curing of the layer adjacent to the layer, the elastomers of which are predominantly TPEs.

In order to improve this adhesion, the Applicant Companies have previously described laminates for tyres comprising a layer, the elastomers of which are predominantly thermoplastic elastomers (TPEs), for example in the document WO2010/063427. In this document, the layer predominantly composed of TPE can adhere to a diene layer by the presence of a specific intermediate adhesive layer. While it is effective, the resulting laminate adds an additional layer to the structure of the tyre, which makes it heavier and adds a stage in the manufacture thereof.

With the aim of improving conventional tyres by the use of a layer predominantly based on a TPE elastomer, while simplifying the adhesion of such a layer to an adjacent crosslinked or non-crosslinked diene layer, the Applicant Company has found, surprisingly, the laminate of the invention.

A subject-matter of the invention is thus an elastomeric laminate for tyres, the said laminate comprising at least two adjacent layers of elastomer:
a first layer, composed of a composition based on at least one thermoplastic elastomer (TPE), the content of thermoplastic elastomer being within a range extending from more than 50 to 100 phr (parts by weight per 100 parts by weight of elastomer);
a second layer, composed of a composition based on at least one diene elastomer, the content of diene elastomer being within a range extending from more than 50 to 95 phr, and on at least one thermoplastic elastomer (TPE), the content of thermoplastic elastomer being within a range extending from 5 to less than 50 phr;
   it being understood that at least 5 phr of the thermoplastic elastomers present in the second layer are compatible with at least 5 phr of the elastomers present in the first layer.

This compatibility makes it possible to have a satisfactory adhesion between the two layers of the multilayer laminate of the invention. In comparison with the solutions of the prior art, the invention is of great simplicity, since it makes it possible to dispense with a layer, the only role of which would be the adhesion of the TPE layer to the diene layer, and thus not to make the tyre heavier and thus not to increase its rolling resistance.

Another major advantage of the invention is to make possible a saving in materials since, instead of using an additional elastomeric layer for the adhesion, the invention makes it possible for a predominantly diene layer (like the compositions of conventional tyres) to adhere to a thermoplastic layer. This saving is furthermore highly favourable to the protection of the environment.

Preferably, the invention relates to a laminate as defined above, in which the number-average molecular weight of the thermoplastic elastomers is between 30 000 and 500 000 g/mol.

Preferably again, the invention relates to a laminate as defined above, in which the elastomer blocks of the thermoplastic elastomers are chosen from elastomers having a glass transition temperature of less than 25° C.

Preferably, the invention relates to a laminate as defined above, in which the elastomer blocks of the thermoplastic elastomers are selected from the group consisting of ethylene elastomers, diene elastomers and their mixtures. According to a preferred form, the elastomer blocks of the thermoplastic elastomers are chosen from ethylene elastomers. According to another preferred form, the elastomer blocks of the thermoplastic elastomers are chosen from diene elastomers and more preferably diene elastomers resulting from isoprene, butadiene or a mixture of these.

Preferably again, the invention relates to a laminate as defined above, in which the thermoplastic blocks of the thermoplastic elastomers are chosen from polymers having a glass transition temperature of greater than 60° C. and, in the case of a semicrystalline thermoplastic block, a melting point of greater than 60° C. More preferably, the thermoplastic blocks of the thermoplastic elastomers are selected from the group consisting of polyolefins, polyurethanes, polyamides, polyesters, polyacetals, polyethers, polyphenylene sulphides, polyfluorinated compounds, polystyrenes, polycarbonates, polysulphones, polymethyl methacrylate, polyetherimide, thermoplastic copolymers and their mixtures. More preferably still, the thermoplastic blocks of the thermoplastic elastomers are chosen from polystyrenes. More preferably still, the thermoplastic elastomers (TPEs) comprise between 5% and 50% by weight of styrene.

Preferably, the invention relates to a laminate as defined above, in which the thermoplastic elastomers are selected from the group consisting of styrene/ethylene/butylene (SEB), styrene/ethylene/propylene (SEP), styrene/ethylene/ethylene/propylene (SEEP), styrene/ethylene/butylene/styrene (SEBS), styrene/ethylene/propylene/styrene (SEPS), styrene/ethylene/ethylene/propylene/styrene (SEEPS), styrene/isobutylene (SIB), styrene/isobutylene/styrene (SIBS), styrene/butadiene (SB), styrene/isoprene (SI), styrene/butadiene/isoprene (SBI), styrene/butadiene/styrene (SBS), styrene/isoprene/styrene (SIS), styrene/butadiene/isoprene/styrene (SBIS), styrene/butadiene/butylene (SBB) and styrene/butadiene/butylene/styrene (SBBS) copolymer thermoplastic elastomers and the mixtures of these copolymers.

Preferably, the invention relates to a laminate as defined above, in which the content of thermoplastic elastomer (TPE) in the composition of the first layer is within a range extending from 70 to 100 phr and more preferably from 80 to 100 phr. More preferably still, the thermoplastic elastomer is the only elastomer of the first layer.

More preferably, the invention relates to a laminate as defined above, in which the first layer does not comprise a crosslinking system.

Preferably, the invention relates to a laminate as defined above, in which the content of thermoplastic elastomer (TPE) in the composition of the second layer is within a range extending from 5 to 45 phr, more preferably from 10 to 40 phr.

Preferably, the invention relates to a laminate as defined above, in which the diene elastomer of the second layer is selected from the group consisting of essentially unsaturated diene elastomers and the mixtures of these elastomers. More preferably, the diene elastomer is selected from the group consisting of the homopolymers obtained by polymerization of a conjugated diene monomer having from 4 to 12 carbon atoms, the copolymers obtained by copolymerization of one or more conjugated dienes with one another or with one or more vinylaromatic compounds having from 8 to 20 carbon atoms, and the mixtures of these. More preferably still, the diene elastomer is selected from the group consisting of polybutadienes, synthetic polyisoprenes, natural rubber, butadiene copolymers, isoprene copolymers and the mixtures of these elastomers.

Preferably, the invention relates to a laminate as defined above, in which the second layer comprises a reinforcing filler. Preferably, the reinforcing filler is carbon black and/or silica. More preferably, the predominant reinforcing filler is a carbon black.

The invention also relates to a tyre comprising a laminate as defined above.

Furthermore, the invention also relates to the use, in a pneumatic object, of a laminate as defined above.

The invention relates more particularly to the laminates as defined above, used in tyres intended to equip non-motor vehicles, such as bicycles, or motor vehicles of passenger vehicle type, SUVs (“Sport Utility Vehicles”), two-wheel vehicles (in particular motorcycles), aircraft, as well as industrial vehicles chosen from vans, “heavy-duty” vehicles—that is to say, underground trains, buses, road transport vehicles (lorries, tractors, trailers) or off-road vehicles, such as agricultural vehicles or vehicles for construction work —, or other transportation or handling vehicles.

The invention and its advantages will be easily understood in the light of the description and implementational examples which follow.

### DETAILED DESCRIPTION OF THE INVENTION

In the present description, unless expressly indicated otherwise, all the percentages (%) shown are percentages by weight.

Furthermore, the term “phr” means, within the meaning of the present patent application, parts by weight per hundred parts of elastomer, thermoplastic and diene mixed together. Within the meaning of the present invention, thermoplastic elastomers (TPEs) are included among the elastomers.

Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

For the requirements of the present invention, it is specified that, in the present patent application, “thermoplastic layer” denotes an elastomeric layer comprising, by weight, a greater amount of thermoplastic elastomer(s) than of diene elastomer(s) and “diene layer” denotes an elastomeric layer comprising, by weight, a greater amount of diene elastomer(s) than of thermoplastic elastomer(s).

The laminate according to the invention exhibits an excellent adhesion between the two layers denoted, for the requirement of clarity of the invention, first and second layers (or respectively thermoplastic layer and diene layer). Thus, according to the invention, a thermoplastic layer as defined above can adhere with a diene layer as defined above, by virtue of the presence of a certain amount of TPE in this diene layer, compatible with a certain amount of TPE in the thermoplastic layer.

Within the meaning of the present invention, thermoplastic elastomers are compatible when they exhibit, as a mixture (of these two thermoplastic elastomers with one another), a single glass transition temperature or, in the case of semicrystalline thermoplastic blocks, a single melting point for the thermoplastic part of the mixture.

The details of the invention will be explained below by the description, in a first step, of the possible common constituents of the two layers of the laminate of the invention, then, in a second step, by the description of the specific components of each of the layers of the laminate of the invention and, finally, by the description of the adhesion between the two layers of the laminate according to the invention.

### I—POSSIBLE COMMON CONSTITUENTS OF THE LAYERS OF THE MULTILAYER LAMINATE

The multilayer laminate according to the invention has the essential characteristic of being provided with at least two elastomeric layers referred to as “thermoplastic layer” and “diene layer” with different formulations, the said layers of the said multilayer laminate comprising at least one thermoplastic elastomer as defined below. In addition to the TPE, at least the diene layer also comprises a diene elastomer as defined below.

In addition to the elastomers, the layers of the multilayer laminate of the invention can comprise other non-essential components which are preferably present or not present, among which mention may in particular be made of those which are presented below, with the elastomers discussed above.

I-1. Thermoplastic Elastomer (TPE)

Thermoplastic elastomers (abbreviated to “TPEs”) have a structure intermediate between elastomers and thermoplastic polymers. These are block copolymers composed of rigid thermoplastic blocks connected via flexible elastomer blocks.

The thermoplastic elastomer used for the implementation of the invention is a block copolymer, the chemical nature of the thermoplastic and elastomer blocks of which can vary.

I-1.1. Structure of the TPE

The number-average molecular weight (denoted Mn) of the TPE is preferably between 30 000 and 500 000 g/mol, more preferably between 40 000 and 400 000 g/mol. Below the minima indicated, there is a risk of the cohesion between the elastomer chains of the TPE being affected, in particular due to its possible dilution (in the presence of an extending oil); furthermore, there is a risk of an increase in the working temperature affecting the mechanical properties, in particular the properties at break, with the consequence of a reduced “hot” performance. Furthermore, an excessively high Mn weight can be damaging to the implementation. Thus, it has been found that a value within a range from 50 000 to 300 000 g/mol is particularly well suited, in particular to use of the TPE in a tyre multilayer laminate composition.

The number-average molecular weight (Mn) of the TPE elastomer is determined in a known way by steric exclusion chromatography (SEC). For example, in the case of styrene thermoplastic elastomers, the sample is dissolved beforehand in tetrahydrofuran at a concentration of approximately 1 g/l and then the solution is filtered through a filter with a porosity of 0.45 μm before injection. The apparatus used is a Waters Alliance chromatographic line. The elution solvent is tetrahydrofuran, the flow rate is 0.7 ml/min, the temperature of the system is 35° C. and the analytical time is 90 min. A set of four Waters columns in series, with the Styragel tradenames (HMW7, HMW6E and two HT6E), is used. The injected volume of the solution of the polymer sample is 100 μl. The detector is a Waters 2410 differential refractometer, and its associated software, for making use of the chromatographic data, is the Waters Millennium system. The calculated average molar masses are relative to a calibration curve produced with polystyrene standards. The conditions can be adjusted by a person skilled in the art.

The value of the polydispersity index PI (reminder: PI=Mw/Mn, with Mw the weight-average molecular weight and Mn the number-average molecular weight) of the TPE is preferably less than 3, more preferably less than 2 and more preferably still less than 1.5.

In the present patent application, when reference is made to the glass transition temperature of the TPE, it concerns the Tg relative to the elastomer block. The TPE preferably exhibits a glass transition temperature (“Tg”) which is preferably less than or equal to 25° C., more preferably less than or equal to 10° C. A Tg value greater than these minima can reduce the performance of the multilayer laminate when used at very low temperature; for such a use, the Tg of the TPE is more preferably still less than or equal to −10° C. Preferably again, the Tg of the TPE is greater than −100° C.

In a known way, TPEs exhibit two glass transition temperature peaks (Tg, measured according to ASTM D3418), the lowest temperature being relative to the elastomer part of the TPE and the highest temperature being relative to the thermoplastic part of the TPE. Thus, the flexible blocks of the TPEs are defined by a Tg which is less than ambient temperature (25° C.), while the rigid blocks have a Tg which is greater than 60° C.

In order to be both elastomeric and thermoplastic in nature, the TPE has to be provided with blocks which are sufficiently incompatible (that is to say, different as a result of their respective weights, their respective polarities or their respective Tg values) to retain their own properties of elastomer block or thermoplastic block.

The TPEs can be copolymers with a small number of blocks (less than 5, typically 2 or 3), in which case these blocks preferably have high weights of greater than 15 000 g/mol. These TPEs can, for example, be diblock copolymers, comprising a thermoplastic block and an elastomer block. They are often also triblock elastomers with two rigid segments connected by a flexible segment. The rigid and flexible segments can be positioned linearly, or in a star or branched configuration. Typically, each of these segments or blocks often comprises a minimum of more than 5, generally of more than 10, base units (for example, styrene units and butadiene units for a styrene/butadiene/styrene block copolymer).

The TPEs can also comprise a large number of smaller blocks (more than 30, typically from 50 to 500), in which case these blocks preferably have relatively low weights, for example from 500 to 5000 g/mol; these TPEs will subsequently be referred to as multiblock TPEs and are an elastomer block/thermoplastic block series.

According to a first alternative form, the TPE is provided in a linear form. For example, the TPE is a diblock copolymer: thermoplastic block/elastomer block. The TPE can also be a triblock copolymer: thermoplastic block/elastomer block/thermoplastic block, that is to say a central elastomer block and two terminal thermoplastic blocks, at each of the two ends of the elastomer block. Equally, the multiblock TPE can be a linear series of elastomer blocks/thermoplastic blocks.

According to another alternative form of the invention, the TPE of use for the requirements of the invention is provided in a star-branched form comprising at least three branches. For example, the TPE can then be composed of a star-branched elastomer block comprising at least three branches and of a thermoplastic block located at the end of each of the branches of the elastomer block. The number of branches of the central elastomer can vary, for example, from 3 to 12 and preferably from 3 to 6.

According to another alternative form of the invention, the TPE is provided in a branched or dendrimer form. The TPE can then be composed of a branched or dendrimer elastomer block and of a thermoplastic block located at the end of the branches of the dendrimer elastomer block.

I-1.2. Nature of the Elastomer Blocks

The elastomer blocks of the TPE for the requirements of the invention can be any elastomer known to a person skilled in the art. They generally have a Tg of less than 25° C., preferably of less than 10° C., more preferably of less than 0° C. and very preferably of less than −10° C. Preferably again, the Tg of the elastomer block of the TPE is greater than to −100° C.

For the elastomer blocks comprising a carbon-based chain, if the elastomer part of the TPE does not comprise an ethylenic unsaturation, it will be referred to as a saturated elastomer block. If the elastomer block of the TPE comprises ethylenic unsaturations (that is to say, carbon-carbon double bonds), it will then be referred to as an unsaturated or diene elastomer block.

A saturated elastomer block is composed of a polymer sequence obtained by the polymerization of at least one (that is to say, one or more) ethylenic monomer, that is to say, a monomer comprising a carbon-carbon double bond. Mention may be made, among the blocks resulting from these ethylenic monomers, of polyalkylene blocks, such as polyisobutylene, polybutylene, polyethylene or polypropylene blocks, or also such as ethylene/propylene or ethylene/butylene random copolymers. These saturated elastomer blocks can also be obtained by hydrogenation of unsaturated elastomer blocks. They can also be aliphatic blocks resulting from the families of the polyethers, polyesters or polycarbonates.

In the case of saturated elastomer blocks, this elastomer block of the TPE is preferably predominantly composed of ethylenic units. Predominantly is understood to mean a content by weight of ethylenic monomer which is the highest, with respect to the total weight of the elastomer block, and preferably a content by weight of more than 50%, more preferably of more than 75% and more preferably still of more than 85%.

Conjugated C₄-C₁₄ dienes can be copolymerized with the ethylenic monomers. They are, in this case, random copolymers. Preferably, these conjugated dienes are chosen from isoprene, butadiene, 1-methylbutadiene, 2-methylbutadiene, 2,3-dimethyl-1,3-butadiene, 2,4-dimethyl-1,3-butadiene, 1,3-pentadiene, 2-methyl-1,3-pentadiene, 3-methyl-1,3-pentadiene, 4-methyl-1,3-pentadiene, 2,3-dimethyl-1,3-pentadiene, 1,3-hexadiene, 2-methyl-1,3-hexadiene, 3-methyl-1,3-hexadiene, 4-methyl-1,3-hexadiene, 5-methyl-1,3-hexadiene, 2,3-dimethyl-1,3-hexadiene, 2,4-dimethyl-1,3-hexadiene, 2,5-dimethyl-1,3-hexadiene, 2-neopentylbutadiene, 1,3-cyclopentadiene, 1,3-cyclohexadiene, 1-vinyl-1,3-cyclohexadiene or their mixture. More preferably, the conjugated diene is chosen from butadiene or isoprene or a mixture comprising butadiene and isoprene.

In the case of unsaturated elastomer blocks, this elastomer block of the TPE is preferably predominantly composed of a diene elastomer part. Predominantly is understood to mean a content by weight of diene monomer which is the highest, with respect to the total weight of the elastomer block, and preferably a content by weight of more than 50%, more preferably of more than 75% and more preferably still of more than 85%. Alternatively, the unsaturation of the unsaturated elastomer block can originate from a monomer comprising a double bond and an unsaturation of cyclic type; this is the case, for example, in polynorbornene.

Preferably, conjugated C₄-C₁₄ dienes can be polymerized or copolymerized in order to form a diene elastomer block. Preferably, these conjugated dienes are chosen from isoprene, butadiene, piperylene, 1-methylbutadiene, 2-methylbutadiene, 2,3-dimethyl-1,3-butadiene, 2,4-dimethyl-1,3-butadiene, 1,3-pentadiene, 2-methyl-1,3-pentadiene, 3-methyl-1,3-pentadiene, 4-methyl-1,3-pentadiene, 2,3-dimethyl-1,3-pentadiene, 2,5-dimethyl-1,3-pentadiene, 2-methyl-1,4-pentadiene, 1,3-hexadiene, 2-methyl-1,3-hexadiene, 2-methyl-1,5-hexadiene, 3-methyl-1,3-hexadiene, 4-methyl-1,3-hexadiene, 5-methyl-1,3-hexadiene, 2,5-dimethyl-1,3-hexadiene, 2,5-dimethyl-2,4-hexadiene, 2-neopentyl-1,3-butadiene, 1,3-cyclopentadiene, methylcyclopentadiene, 2-methyl-1,6-heptadiene, 1,3-cyclohexadiene, 1-vinyl-1,3-cyclohexadiene or their mixture. More preferably, the conjugated diene is isoprene or butadiene or a mixture comprising isoprene and/or butadiene.

According to an alternative form, the monomers polymerized in order to form the elastomer part of the TPE can be randomly copolymerized with at least one other monomer, so as to form an elastomer block. According to this alternative form, the molar fraction of polymerized monomer, other than an ethylenic monomer, with respect to the total number of units of the elastomer block, has to be such that this block retains its elastomer properties. Advantageously, the molar fraction of this other comonomer can range from 0% to 50%, more preferably from 0% to 45% and more preferably still from 0% to 40%.

By way of illustration, this other monomer capable of copolymerizing with the first monomer can be chosen from ethylenic monomers as defined above (for example ethylene), diene monomers, more particularly the conjugated diene monomers having from 4 to 14 carbon atoms as defined above (for example butadiene), monomers of vinylaromatic type having from 8 to 20 carbon atoms as defined below or also it can be a monomer such as vinyl acetate.

When the comonomer is of vinylaromatic type, it advantageously represents a fraction of units, with regard to the total number of units of the thermoplastic block, from 0% to 50%, preferably ranging from 0% to 45% and more preferably still ranging from 0% to 40%. The styrene monomers mentioned above, namely methylstyrenes, para(tert-butyl)styrene, chlorostyrenes, bromostyrenes, fluorostyrenes or also para-hydroxystyrene, are suitable in particular as vinylaromatic compounds. Preferably, the comonomer of vinylaromatic type is styrene.

According to a preferred embodiment of the invention, the elastomer blocks of the TPE exhibit, in total, a number-average molecular weight (Mn) ranging from 25 000 g/mol to 350 000 g/mol, preferably from 35 000 g/mol to 250 000 g/mol, so as to confer, on the TPE, good elastomeric properties and a mechanical strength which is sufficient and compatible with the use as tyre multilayer laminate.

The elastomer block can also be a block comprising several types of ethylenic, diene or styrene monomers as defined above.

The elastomer block can also be composed of several elastomer blocks as defined above.

I-1.3. Nature of the Thermoplastic Blocks

Use will be made, for the definition of the thermoplastic blocks, of the characteristic of glass transition temperature (Tg) of the rigid thermoplastic block. This characteristic is well known to a person skilled in the art. It makes it possible in particular to choose the industrial processing (transformation) temperature. In the case of an amorphous polymer (or polymer block), the processing temperature is chosen to be substantially greater than the Tg of the thermoplastic block. In the specific case of a semicrystalline polymer (or polymer block), a melting point may be observed which is then greater than the glass transition temperature. In this case, it is instead the melting point (M.p.) which makes it possible to choose the processing temperature for the polymer (or polymer block) under consideration. Thus, subsequently, when reference will be made to “Tg (or M.p., if appropriate)”, this will have to be regarded as the temperature used to choose the processing temperature.

For the requirements of the invention, the TPE elastomers comprise one or more thermoplastic block(s) preferably having a Tg (or M.p., if appropriate) of greater than or equal to 60° C. and formed from polymerized monomers. Preferably, this thermoplastic block has a Tg (or M.p., if appropriate) within a range varying from 60° C. to 250° C. Preferably, the Tg (or M.p., if appropriate) of this thermoplastic block is preferably from 70° C. to 200° C., more preferably from 80° C. to 180° C.

The proportion of the thermoplastic blocks, with respect to the TPE as defined for the implementation of the invention, is determined, on the one hand, by the thermoplasticity properties which the said copolymer has to exhibit. The thermoplastic blocks having a Tg (or M.p., if appropriate) of greater than or equal to 60° C. are preferably present in proportions sufficient to retain the thermoplastic nature of the elastomer according to the invention. The minimum content of thermoplastic blocks having a Tg (or M.p., if appropriate) of greater than or equal to 60° C. in the TPE can vary as a function of the conditions of use of the copolymer. On the other hand, the ability of the TPE to deform during the preparation of the tyre can also contribute to determining the proportion of the thermoplastic blocks having a Tg (or M.p., if appropriate) of greater than or equal to 60° C.

The thermoplastic blocks having a Tg (or M.p., if appropriate) of greater than or equal to 60° C. can be formed from polymerized monomers of various natures; in particular, they can constitute the following blocks or their mixtures:
polyolefins (polyethylene, polypropylene);
polyurethanes;
polyamides;
polyesters;
polyacetals;

polyethers (polyethylene oxide, polyphenylene ether);
polyphenylene sulphides;
polyfluorinated compounds (FEP, PFA, ETFE);
polystyrenes (described in detail below);
polycarbonates;
polysulphones;
polymethyl methacrylate;
polyetherimide;
thermoplastic copolymers, such as the acrylonitrile/butadiene/styrene (ABS) copolymer.

The thermoplastic blocks having a Tg (or M.p., if appropriate) of greater than or equal to 60° C. can also be obtained from monomers chosen from the following compounds and their mixtures:

acenaphthylene: a person skilled in the art may refer, for example, to the paper by Z. Fodor and J. P. Kennedy, Polymer Bulletin, 1992, 29(6), 697-705;

indene and its derivatives, such as, for example, 2-methylindene, 3-methylindene, 4-methylindene, dimethylindene, 2-phenylindene, 3-phenylindene and 4-phenylindene; a person skilled in the art may, for example, refer to the patent document U.S. Pat. No. 4,946,899, by the inventors Kennedy, Puskas, Kaszas and Hager, and to the documents by J. E. Puskas, G. Kaszas, J. P. Kennedy and W. G. Hager, Journal of Polymer Science, Part A: Polymer Chemistry (1992), 30, 41, and J. P. Kennedy, N. Meguriya and B. Keszler, Macromolecules (1991), 24(25), 6572-6577;

isoprene, then resulting in the formation of a certain number of trans-1,4-polyisoprene units and of units cyclized according to an intramolecular process; a person skilled in the art may, for example, refer to the documents by G. Kaszas, J. E. Puskas and J. P. Kennedy, Applied Polymer Science (1990), 39(1), 119-144, and J. E. Puskas, G. Kaszas and J. P. Kennedy, Macromolecular Science, Chemistry A28 (1991), 65-80.

The polystyrenes are obtained from styrene monomers. Styrene monomer should be understood as meaning, in the present description, any monomer comprising styrene, unsubstituted and substituted; mention may be made, among substituted styrenes, for example, of methylstyrenes (for example, o-methylstyrene, m-methylstyrene or p-methylstyrene, α-methylstyrene, α,2-dimethylstyrene, α,4-dimethylstyrene or diphenylethylene), para-(tert-butyl)styrene, chlorostyrenes (for example, o-chlorostyrene, m-chlorostyrene, p-chlorostyrene, 2,4-dichlorostyrene, 2,6-dichlorostyrene or 2,4,6-trichlorostyrene), bromostyrenes (for example, o-bromostyrene, m-bromostyrene, p-bromostyrene, 2,4-dibromostyrene, 2,6-dibromostyrene or 2,4,6-tribromostyrene), fluorostyrenes (for example, o-fluorostyrene, m-fluorostyrene, p-fluorostyrene, 2,4-difluorostyrene, 2,6-difluorostyrene or 2,4,6-trifluorostyrene) or also para-hydroxystyrene.

According to a preferred embodiment of the invention, the content by weight of styrene in the TPE elastomer is between 5% and 50%. Below the minimum indicated, there is a risk of the thermoplastic nature of the elastomer being substantially reduced while, above the recommended maximum, the elasticity of the multilayer laminate can be affected. For these reasons, the styrene content is more preferably between 10% and 40%.

According to an alternative form of the invention, the polymerized monomer as defined above can be copolymerized with at least one other monomer, so as to form a thermoplastic block having a Tg (or M.p., if appropriate) as defined above.

By way of illustration, this other monomer capable of copolymerizing with the polymerized monomer can be chosen from diene monomers, more particularly conjugated diene monomers having from 4 to 14 carbon atoms, and monomers of vinylaromatic type having from 8 to 20 carbon atoms, such as defined in the part relating to the elastomer block.

According to the invention, the thermoplastic blocks of the TPE exhibit, in total, a number-average molecular weight (“Mn”) ranging from 5 000 g/mol to 150 000 g/mol, so as to confer, on the TPE, good elastomeric properties and a mechanical strength which is sufficient and compatible with the use as tyre multilayer laminate.

The thermoplastic block can also be composed of several thermoplastic blocks as defined above.

I-1.4. TPE Examples

For example, the TPE is a copolymer, the elastomer part of which is saturated and which comprises styrene blocks and alkylene blocks. The alkylene blocks are preferably of ethylene, propylene or butylene. More preferably, this TPE elastomer is selected from the following group consisting of diblock or triblock copolymers which are linear or star-branched: styrene/ethylene/butylene (SEB), styrene/ethylene/propylene (SEP), styrene/ethylene/ethylene/propylene (SEEP), styrene/ethylene/butylene/styrene (SEBS), styrene/ethylene/propylene/styrene (SEPS), styrene/ethylene/ethylene/propylene/styrene (SEEPS), styrene/isobutylene (SIB), styrene/isobutylene/styrene (SIBS) and the mixtures of these copolymers.

According to another example, the TPE is a copolymer, the elastomer part of which is unsaturated and which comprises styrene blocks and diene blocks, these diene blocks being in particular isoprene or butadiene blocks. More preferably, this TPE elastomer is selected from the following group consisting of diblock or triblock copolymers which are linear or star-branched: styrene/butadiene (SB), styrene/isoprene (SI), styrene/butadiene/isoprene (SBI), styrene/butadiene/styrene (SBS), styrene/isoprene/styrene (SIS), styrene/butadiene/isoprene/styrene (SBIS) and the mixtures of these copolymers.

For example again, the TPE is a linear or star-branched copolymer, the elastomer part of which comprises a saturated part and an unsaturated part, such as, for example, styrene/butadiene/butylene (SBB), styrene/butadiene/butylene/styrene (SBBS) or a mixture of these copolymers.

Mention may be made, among multiblock TPEs, of the copolymers comprising random copolymer blocks of ethylene and propylene/polypropylene, polybutadiene/polyurethane (TPU), polyether/polyester (COPE) or polyether/polyamide (PEBA).

It is also possible for the TPEs given as example above to be mixed with one another within the layers of the multilayer laminate according to the invention.

Mention may be made, as examples of commercially available TPE elastomers, of the elastomers of SEPS, SEEPS or SEBS type sold by Kraton under the Kraton G name (e.g., G1650, G1651, G1654 and G1730 products) or Kuraray under the Septon name (e.g., Septon 2007, Septon 4033 or Septon 8004), or the elastomers of SIS type sold by Kuraray under the name Hybrar 5125 or sold by Kraton under the name D1161, or also the elastomers of linear SBS type sold by Polimeri Europa under the name Europrene SOLT 166 or of star-branched SBS type sold by Kraton under the name D1184. Mention may also be made of the elastomers sold by Dexco Polymers under the Vector name (e.g., Vector 4114 or Vector 8508). Mention may be made, among multiblock TPEs, of the Vistamaxx TPE sold by Exxon; the COPE TPE sold by DSM under the Arnitel name or by DuPont under the Hytrel name or by Ticona under the Riteflex name; the PEBA TPE sold by Arkema under the PEBAX name; or the TPU TPE sold by Sartomer under the name TPU 7840 or by BASF under the Elastogran name.

I-1.5. TPE Amount

It has already been indicated that the amounts of TPE vary according to the layer of the laminate according to the invention. In at least one layer, the amount of TPE, of more than 50 phr, is greater than the amount of diene elastomers (thermoplastic layer) and, in at least one layer, it is the reverse: the diene layer comprises more than 50 phr of diene elastomer(s). The more precise and preferred amounts of TPE in each of the layers will be clarified later with the specific features of each of the layers of the laminate of the invention.

I-2. Diene Elastomer

The thermoplastic elastomer or elastomers described above are sufficient in themselves alone for the thermoplastic layer of the multilayer laminate according to the invention to be usable; however, diene elastomers can be used in this thermoplastic layer and, as for the diene layer, the latter comprises more diene elastomer(s) than thermoplastic elastomer(s).

Thus, the multilayer laminate according to the invention comprises at least one (that is to say, one or more) diene elastomer, which can be used alone or as a blend with at least one (that is to say, one or more) other diene elastomer (or rubber).

The content of diene elastomer, which is or is not optional, in each of the layers of the laminate of the invention will be clarified later with the specific features of each of the layers of the laminate of the invention.

“Diene” elastomer or rubber should be understood, in a known way, as meaning an (one or more is understood) elastomer resulting at least in part (i.e., a homopolymer or a copolymer) from diene monomers (monomers bearing two conjugated or non-conjugated carbon-carbon double bonds).

These diene elastomers can be classified into two categories: “essentially unsaturated” or “essentially saturated”.

“Essentially unsaturated” is understood to mean generally a diene elastomer resulting at least in part from conjugated diene monomers having a content of units of diene origin (conjugated dienes) which is greater than 15% (mol %). In the category of “essentially unsaturated” diene elastomers, “highly unsaturated” diene elastomer is understood to mean in particular a diene elastomer having a content of units of diene origin (conjugated dienes) which is greater than 50%.

Thus it is that diene elastomers, such as some butyl rubbers or copolymers of dienes and of α-olefins of EPDM type, can be described as “essentially saturated” diene elastomers (low or very low content of units of diene origin, always less than 15%).

Given these definitions, diene elastomer, whatever the above category, capable of being used in the compositions in accordance with the invention is understood more particularly to mean:

(a)—any homopolymer obtained by polymerization of a conjugated diene monomer having from 4 to 12 carbon atoms;
(b)—any copolymer obtained by copolymerization of one or more conjugated dienes with one another or with one or more vinylaromatic compounds having from 8 to 20 carbon atoms;
(c)—a ternary copolymer obtained by copolymerization of ethylene and of an α-olefin having from 3 to 6 carbon atoms with a non-conjugated diene monomer having from 6 to 12 carbon atoms, such as, for example, the elastomers obtained from ethylene and propylene with a non-conjugated diene monomer of the abovementioned type, such as, in particular, 1,4-hexadiene, ethylidenenorbornene or dicyclopentadiene;
(d)—a copolymer of isobutene and of isoprene (diene butyl rubber) and also the halogenated versions, in particular chlorinated or brominated versions, of this type of copolymer.

Any type of diene elastomer can be used in the invention. When the composition comprises a vulcanization system, use is preferably made of essentially unsaturated elastomers, in particular of the (a) and (b) types above, in the manufacture of the multilayer laminate according to the present invention.

The following are suitable in particular as conjugated dienes: 1,3-butadiene, 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene. The following, for example, are suitable as vinylaromatic compounds: styrene, ortho-, meta- or para-methylstyrene, the “vinyltoluene” commercial mixture, para-(tert-butyl)styrene, methoxystyrenes, chlorostyrenes, vinylmesitylene, divinylbenzene or vinylnaphthalene.

The copolymers can comprise between 99% and 20% by weight of diene units and between 1% and 80% by weight of vinylaromatic units. The elastomers can have any microstructure, which depends on the polymerization conditions used, in particular on the presence or absence of a modifying and/or randomizing agent and on the amounts of modifying and/or randomizing agent employed. The elastomers can, for example, be prepared in dispersion or in solution; they can be coupled and/or star-branched or else functionalized with a coupling and/or star-branching or functionalization agent. Mention may be made, for example, for coupling to carbon black, of functional groups comprising a C—Sn bond or aminated functional groups, such as benzophenone, for example; mention may be made, for example, for coupling to a reinforcing inorganic filler, such as silica, of silanol functional groups or polysiloxane functional groups having a silanol end (such as described, for example, in FR 2 740 778 or U.S. Pat. No. 6,013,718), alkoxysilane groups (such as described, for example, in FR 2 765 882 or U.S. Pat. No. 5,977,238), carboxyl groups (such as described, for example, in WO 01/92402 or U.S. Pat. No. 6,815,473, WO 2004/096865 or US 2006/0089445) or else polyether groups (such as described, for example, in EP 1 127 909 or U.S. Pat. No. 6,503,973). Mention may also be made, as other examples of functionalized elastomers, of elastomers (such as SBR, BR, NR or IR) of the epoxidized type.

I-3. Nanometric (or Reinforcing) and Micrometric (or Non-Reinforcing) Fillers

The elastomers described above are sufficient in themselves alone for the multilayer laminate according to the invention to be usable; nevertheless, a reinforcing filler can be used in the composition and in particular in the diene layer of the laminate of the invention.

When a reinforcing filler is used, use may be made of any type of filler generally used for the manufacture of tyres, for example an organic filler, such as carbon black, an inorganic filler, such as silica, or also a blend of these two types of filler, in particular a blend of carbon black and silica.

When a reinforcing inorganic filler is used, it is possible, for example, to use, in a known way, an at least bifunctional coupling agent (or bonding agent) intended to provide a satisfactory connection, of chemical and/or physical nature, between the inorganic filler (surface of its particles) and the elastomer, in particular bifunctional organosilanes or polyorganosiloxanes.

In the same way, the composition of the layers of the multilayer laminate of the invention can comprise one or more micrometric fillers, referred to as “non-reinforcing” or inert fillers, such as the platy fillers known to a person skilled in the art.

I-4. Various Additives

The multilayer laminate of the invention can furthermore comprise the various additives normally present in tyre elastomeric layers known to a person skilled in the art. The choice will be made, for example, of one or more additives chosen from protection agents, such as antioxidants or antiozonants, UV stabilizers, the various processing aids or other stabilizers, or promoters capable of promoting the adhesion to the remainder of the structure of the tyre. Preferably, the thermoplastic layer of the multilayer laminate does not comprise all these additives at the same time and preferably, in some cases, the multilayer laminate does not comprise any of these agents.

Equally and optionally, the composition of the layers of the multilayer laminate of the invention can comprise a crosslinking system known to a person skilled in the art. Preferably, the composition does not comprise a crosslinking system.

Optionally again, the composition of the layers of the multilayer laminate of the invention can comprise a plasticizing agent, such as an extending oil (or plasticizing oil) or a plasticizing resin, the role of which is to facilitate the processing of the multilayer laminate, in particular its incorporation in the tyre, by a lowering of the modulus and an increase in the tackifying power.

In addition to the elastomers described above, the compositions of the multilayer laminate can also comprise, always according to a minor fraction by weight with respect to the block elastomer, one or more (non-elastomeric) thermoplastic polymers, such as those based on polyether.

### II—MULTILAYER LAMINATE

As indicated above, the multilayer laminate of the invention thus has the essential characteristic of comprising at least two adjacent layers of elastomer:
a first layer, composed of a composition based on at least one thermoplastic elastomer (TPE), the content of thermoplastic elastomer being within a range extending from more than 50 to 100 phr (parts by weight per 100 parts by weight of elastomer);
a second layer, composed of a composition based on at least one diene elastomer, the content of diene elastomer being within a range extending from more than 50 to 95 phr, and on at least one thermoplastic elastomer (TPE), the content of thermoplastic elastomer being within a range extending from 5 to less than 50 phr;
   it being understood that at least 5 phr of the thermoplastic elastomers present in the second layer are compatible with at least 5 phr of the elastomers present in the first layer.

II-1. First Layer or Thermoplastic Layer

Use is made, as first, thermoplastic, layer, of an elastomeric composition comprising more than 50 phr of TPE elastomer as defined above, with all the preferences for structure and chemical nature of the thermoplastic and elastomeric blocks expressed above.

The thermoplastic layer described above might optionally comprise other elastomers than the TPEs, diene elastomers, in a minor amount (at most 50 phr). Such diene elastomers are defined above and the composition of the thermoplastic layer can optionally and preferably also comprise other components, such as those presented above and in common with the second layer of the laminate of the invention.

Preferably, the content of TPE in the first layer is within a range extending from 70 to 100 phr, in particular within a range extending from 80 to 100 phr.

However, according to a particularly preferred embodiment, the TPE or TPEs are the only elastomers present in the thermoplastic layer; consequently, in such a case, at a content equal to 100 phr.

II-2. Second Layer or Diene Layer

Use is made, as second layer, in combination with the first layer, of an elastomer composition, the essential characteristic of which is to comprise an amount varying from 5 to less than 50 phr of TPE, as replacement for a part of the diene elastomer. Thus, the content of diene elastomer in this second layer is between 50 and 95 phr. Below the minimum content of TPE, the adhesive effect is not sufficient whereas, above the recommended maximum, the properties of the diene layer are detrimentally affected to an excessive extent by the strong presence of TPE.

According to another preferred embodiment of the invention, the content of TPE (that is to say, the total content, if there are several TPEs) is within a range varying from 5 to 45 phr and more preferably from 10 to 40 phr. Consequently, the content of diene elastomer (that is to say, the total content, if there are several of them) is preferably within a range extending from 55 to 95 phr and more preferably from 60 to 90 phr.

### III—ADHESION OF THE TWO LAYERS OF THE LAMINATE

It has been found that the adhesion of the first layer to the second layer in the laminate of the invention is markedly improved in comparison with the adhesion of a layer of the type of the first layer of the laminate of the invention to a conventional diene layer (that is to say, devoid of thermoplastic elastomer).

This adhesion is expressed by the compatibility of the TPEs present in the layers of the laminate of the invention. Thus, for the requirements of the invention, it is essential for at least 5 phr (and more preferably still 10 phr) of the thermoplastic elastomers present in the second layer to be compatible with at least 5 phr of the elastomers present in the first layer. As indicated above, thermoplastic elastomers are compatible when they exhibit, as a mixture (of these thermoplastic elastomers with one another), a single glass transition temperature or, in the case of semicrystalline thermoplastic blocks, a single melting point for the thermoplastic part of the mixture.

Preferably, at least 5 phr (and more preferably still 10 phr) of the thermoplastic elastomers present in the second layer are compatible with at least 20 phr of the elastomers present in the first layer and more preferably at least 5 phr (and more preferably still 10 phr) of the thermoplastic elastomers present in the second layer are compatible with at least 50 phr of the elastomers present in the first layer.

More preferably, at least 5 phr (and more preferably still 10 phr) of the thermoplastic elastomers present in the second layer are of the same chemical nature as at least 5 phr of the elastomers present in the first layer. TPEs are of the same chemical nature if they comprise thermoplastic blocks comprising the same chemical functional groups (polystyrenes, polyamides, and the like). Preferably, at least 5 phr (and more preferably still 10 phr) of the thermoplastic elastomers present in the second layer are of the same chemical nature as at least 20 phr of the elastomers present in the first layer and more preferably still at least 5 phr (and more preferably still 10 phr) of the thermoplastic elastomers present in the second layer are of the same chemical nature as at least 50 phr of the elastomers present in the first layer.

Very preferably, at least 5 phr (and more preferably still 10 phr) of the thermoplastic elastomers present in the second layer have thermoplastic blocks identical to the thermoplastic blocks of at least 5 phr of the elastomers present in the first layer. Preferably, at least 5 phr (and more preferably still 10 phr) of the thermoplastic elastomers present in the second layer have thermoplastic blocks identical to the thermoplastic blocks of at least 20 phr of the elastomers present in the first layer and more preferably at least 5 phr (and more preferably still 10 phr) of the thermoplastic elastomers present in the second layer have thermoplastic blocks identical to the thermoplastic blocks of at least 50 phr of the elastomers present in the first layer.

### IV—USE OF THE LAMINATE IN A TYRE

The laminate of the invention can be used in any type of tyre. It is particularly well-suited to use in a tyre, tyre finished product or tyre semi-finished product made of rubber, very particularly in a tyre for a motor vehicle, such as a vehicle of two-wheel, passenger vehicle or industrial type, or a non-automobile vehicle, such as a bicycle.

The laminate of the invention can be manufactured by combining the layers of the laminate before curing or even after curing. More specifically, as the thermoplastic layer does not require curing, it can be combined with the diene layer of the laminate of the invention before or after the curing of this diene layer, which itself requires curing before being used in a tyre.

The multilayer laminate of the invention can advantageously be used in the tyres of all types of vehicles, in particular in the tyres for passenger vehicles capable of running at a very high speed or the tyres for industrial vehicles, such as heavy-duty vehicles.

### V. PREPARATION OF THE LAMINATE

The multilayer laminate of the invention is prepared according to methods known to a person skilled in the art, by separately preparing the two layers of the laminate and by then combining the thermoplastic layer with the diene layer, before or after the curing of the latter. The combining of the thermoplastic layer with the diene layer can be carried out under the action of heat and optionally of pressure.

V-1. Preparation of the Thermoplastic Layer

The thermoplastic layer of the multilayer laminate of the invention is prepared conventionally, for example by incorporation of the various components in a twin-screw extruder, so as to carry out the melting of the matrix and an incorporation of all the ingredients, followed by use of a flat die which makes it possible to produce the thermoplastic layer. More generally, the shaping of the TPE can be carried out by any method known to a person skilled in the art: extrusion, calendering, extrusion-blow moulding, injection moulding or cast film.

V-2. Preparation of the Diene Layer

The diene layer of the multilayer laminate of the invention is prepared in appropriate mixers, using two successive phases of preparation according to a general procedure well known to a person skilled in the art: a first phase of thermomechanical working or kneading (sometimes referred to as “non-productive” phase) at high temperature, up to a maximum temperature of between 130° C. and 200° C., preferably between 145° C. and 185° C., followed by a second phase of mechanical working (sometimes referred to as “productive” phase) at lower temperature, typically below 120° C., for example between 60° C. and 100° C., during which finishing phase the crosslinking or vulcanization system is incorporated.

According to a preferred embodiment of the invention, all the base constituents of the compositions of the invention, with the exception of the vulcanization system, such as the TPE elastomers or the optional fillers, are intimately incorporated, by kneading, in the diene elastomer during the first “non-productive” phase, that is to say that at least these various base constituents are introduced into the mixer and are thermomechanically kneaded, in one or more stages, until the maximum temperature of between 130° C. and 200° C., preferably of between 145° C. and 185° C., is reached.

By way of example, the first (non-productive) phase is carried out in a single thermomechanical stage during which all the necessary constituents, the optional supplementary covering agents or processing aids and various other additives, with the exception of the vulcanization system, are introduced into an appropriate mixer, such as an ordinary internal mixer. The total duration of the kneading, in this non-productive phase, is preferably between 1 and 15 min. After cooling the mixture thus obtained during the first non-productive phase, the vulcanization system is then incorporated at low temperature, generally in an external mixer, such as an open mill; everything is then mixed (productive phase) for a few minutes, for example between 2 and 15 min.

The final composition thus obtained is subsequently calendered, for example in the form of a layer denoted, in the present invention, diene layer.

V-3. Preparation of the Laminate

The multilayer laminate of the invention is prepared by combining the thermoplastic layer with the diene layer, before or after curing the latter. Before curing, this consists in laying the thermoplastic layer on the diene layer, in order to form the laminate of the invention, and in then carrying out the curing of the laminate or of the tyre provided with the said laminate. After curing, the thermoplastic layer is placed on the precured diene layer. In order for the adhesion to be able to be established, a temperature is needed at the interface which is greater than the processing temperature of the TPE, itself greater than the glass transition temperature (Tg) and, in the case of a semicrystalline thermoplastic block, than the melting point (M.p.) of the said TPE, optionally in combination with the application of pressure.

### VI—EXAMPLES

### VI-1. Preparation of the Examples

The examples of multilayer laminate of the invention are prepared as indicated above.

### VI-2. Description of the Tests Used

The examples of multilayer laminate of the invention are tested with regard to the adhesion of the thermoplastic layer to the diene layer according to a “peel” test.

The peel test specimens are produced by bringing the two layers of the laminate into contact, each of the layers being reinforced by a fabric (so as to limit the deformation of the said layers under traction). An incipient crack is inserted between the two layers.

According to whether the adhesion is evaluated before or after curing, the mixture of the diene layer is respectively precured (180° C. for 10 minutes) or non-cured. In all cases, the laminate test specimen, once assembled, is brought to 180° C. under pressure for 10 minutes. Strips with a width of 30 mm were cut out using a cutting machine. The two sides of the incipient crack were subsequently placed in the jaws of a tensile testing device with the Intron® trade name. The tests are carried out at ambient temperature and at a pull rate of 100 mm/min. The tensile stresses are recorded and the latter are standardized by the width of the test specimen. A curve of strength per unit of width (in N/mm) as a function of the movable crossrail displacement of the tensile testing device (between 0 and 200 mm) is obtained. The adhesion value selected corresponds to the initiation of failure in the test specimen and thus to the maximum value of this curve. The performances of the examples are standardized with respect to the control (base 100).

### VI-3. Laminate Examples

### VI-3-1. Example 1

In a first step, a multilayer laminate thermoplastic composition and various diene layers were prepared, assembled before curing and tested as indicated above; the compositions are presented in Tables 1A and 1B below, while their combinations and adhesion results are presented in Table 2 below.

The results presented in Table 2 demonstrate the excellent results in adhesion of to the laminate according to the invention, compared with a situation in which the thermoplastic layer is combined with a conventional diene layer (that is to say, not comprising any TPE at all in its composition). It is also noted that the adhesion of the laminate is of the same level as the adhesion of a laminate of two thermoplastic layers represented by the combination of A1 with B5.

TABLE 1A

| Thermoplastic composition | A1 |
|---|---|
| SIBS 102T, Kaneka (phr) | 100 |
| PIB H1200 oil, Ineos (phr) | 65 |
| SYA21R platy filler, Yamagushi (phr) | 28 |
| SYA21R platy filler, Yamagushi (% by | 5 |
| volume) | |

TABLE 1B

| Diene composition | B1 | B2 | B3 | B4 | B5 |
|---|---|---|---|---|---|
| NR (1) | 55 | 38 | 38 | 42 | 24 |
| BR (2) | 20 | 14 | 14 | 28 | 16 |
| SBR (3) | 25 | 16 | 16 | 0 | 0 |
| SIS (4) | 0 | 32 | 0 | 0 | 0 |
| SEBS (5) | 0 | 0 | 32 | 0 | 0 |
| SIBS (6) | 0 | 0 | 0 | 30 | 60 |
| Carbon black (7) | 42 | 42 | 42 | 60 | 60 |
| Plasticizer (8) | 14 | 14 | 14 | 0 | 0 |
| Antioxidant (9) | 1.5 | 1.5 | 1.5 | 1.5 | 1.5 |
| Stearic acid | 1 | 1 | 1 | 0.5 | 0.5 |
| ZnO | 3 | 3 | 3 | 3 | 3 |
| Sulphur | 2 | 2 | 2 | 2.5 | 2.5 |
| Accelerator (10) | 1 | 1 | 1 | 1.5 | 1.5 |

(1) NR Natural rubber
(2) BR Polybutadiene with 4% of 1,2- units and 93% of cis-1,4- units (Tg = −106° C.)
(3) Solution SBR, copolymer of tireand butadiene with 25% of styrene units and 48% of 1,2- units of the butadiene part (Tg of −48° C.)
(4) SIS, D1161, sold by Kraton
(5) SEBS, G1654, sold by Kraton
(6) SIBS, Sibstar 102 T, sold by Kaneka
(7) ASTM N347 or ASTM N683 grade, sold by Cabot
(8) MES oil, Catenex SNR, sold by Shell
(9) N-(1,3-Dimethylbutyl)-N′-phenyl-p-phenylenediamine, 6-PPD, from Flexsys
(10) N-Cyclohexyl-2-benzothiazolesulphenamide, Santocure CBS, from Flexsys

TABLE 2

| | Multilayer laminate | | | | |
|---|---|---|---|---|---|
| | A1/B1 | | | | A1/B5 |
| | control | A1/B2 | A1/B3 | A1/B4 | control |
| Adhesion | 100 | 264 | 560 | 390 | 472 |
| performance | | | | | |
| (%) | | | | | |

### VI-3-2. Example 2

In a second step, the thermoplastic composition A1 and the layers recorded as A4 and A5 above were prepared, assembled after curing the layers A4 and A5, and tested as indicated above; the adhesion results are presented in Table 3 below. For comparison, the control laminate A1/B1 in which the thermoplastic layer is combined with a conventional diene layer (that is to say, not comprising any TPE at all in its composition) is given in Table 3 (base 100), although it is prepared before curing since, in the light of the pure diene nature of B1, a postcuring preparation would not make it possible to obtain adhesion.

TABLE 3

| | Multilayer laminate | | |
|---|---|---|---|
| | A1/B1 | | A1/B5 |
| | control | A1/B4 | control |
| Adhesion | 100 | 440 | 361 |
| performance | | | |
| (%) | | | |

The results presented in Table 4 demonstrate the excellent results in adhesion of the laminate according to the invention, including after curing the diene layer. It is also noted that the control A1/B5 demonstrates that a TPE content of more than 50 phr in the “diene” layer does not make it possible to obtain as good an adhesion as with the laminate of the invention.

1-26. (canceled)

27. An elastomeric laminate for tires, the laminate comprising at least two superimposed layers of elastomer comprising:
a first layer, composed of a composition based on at least one thermoplastic elastomer, a content of the at least one thermoplastic elastomer being within a range extending from more than 50 to 100 phr;
a second layer, composed of a composition based on at least one diene elastomer, a content of the at least one diene elastomer being within a range extending from more than 50 to 95 phr, and on at least one thermoplastic elastomer, a content of the at least one thermoplastic elastomer being within a range extending from 5 to less than 50 phr,
wherein at least 5 phr of the at least one thermoplastic elastomer present in the second layer are compatible with at least 5 phr of the at least one thermoplastic elastomer present in the first layer.

28. The elastomeric laminate according to claim 27, wherein a number-average molecular weight of the thermoplastic elastomers is between 30,000 and 500,000 g/mol.

29. The elastomeric laminate according to claim 27, wherein elastomer blocks of the thermoplastic elastomers are chosen from elastomers having a glass transition temperature of less than 25° C.

30. The elastomeric laminate according to claim 27, wherein elastomer blocks of the thermoplastic elastomers are selected from the group consisting of ethylene elastomers, diene elastomers and mixtures thereof.

31. The elastomeric laminate according to claim 30, wherein elastomer blocks of the thermoplastic elastomers are chosen from ethylene elastomers.

32. The elastomeric laminate according to claim 30, wherein elastomer blocks of the thermoplastic elastomers are chosen from diene elastomers.

33. The elastomeric laminate according to claim 32, wherein elastomer blocks of the thermoplastic elastomers are diene elastomers resulting from isoprene, butadiene or a mixture thereof.

34. The elastomeric laminate according to claim 27, wherein thermoplastic blocks of the thermoplastic elastomers are chosen from polymers having a glass transition temperature of greater than 60° C. and, in a case of a semicrystalline thermoplastic block, a melting point of greater than 60° C.

35. The elastomeric laminate according to claim 27, wherein thermoplastic blocks of the thermoplastic elastomers are selected from the group consisting of polyolefins, polyurethanes, polyamides, polyesters, polyacetals, polyethers, polyphenylene sulphides, polyfluorinated compounds, polystyrenes, polycarbonates, polysulphones, polymethyl methacrylate, polyetherimide, thermoplastic copolymers and mixtures thereof.

36. The elastomeric laminate according to claim 35, wherein thermoplastic blocks of the thermoplastic elastomers are chosen from polystyrenes.

37. The elastomeric laminate according to claim 36, wherein the thermoplastic elastomers comprise between 5% and 50% by weight of styrene.

38. The elastomeric laminate according to claim 27, wherein the thermoplastic elastomers are selected from the group consisting of styrene/ethylene/butylene, styrene/ethylene/propylene, styrene/ethylene/ethylene/propylene, styrene/ethylene/butylene/styrene, styrene/ethylene/propylene/styrene, styrene/ethylene/ethylene/propylene/styrene, styrene/isobutylene, styrene/isobutylene/styrene, styrene/butadiene, styrene/isoprene, styrene/butadiene/isoprene, styrene/butadiene/styrene, styrene/isoprene/styrene, styrene/butadiene/isoprene/styrene, styrene/butadiene/butylene and styrene/butadiene/butylene/styrene copolymer thermoplastic elastomers and mixtures thereof.

39. The elastomeric laminate according to claim 27, wherein the content of the at least one thermoplastic elastomer in the composition of the first layer is within a range extending from 70 to 100 phr.

40. The elastomeric laminate according to claim 39, wherein the content of the at least one thermoplastic elastomer in the composition of the first layer is within a range extending from 80 to 100 phr.

41. The elastomeric laminate according to claim 27, wherein the at least one thermoplastic elastomer is the only elastomer of the first layer.

42. The elastomeric laminate according to claim 27, wherein the first layer does not comprise a crosslinking system.

43. The elastomeric laminate according to claim 27, wherein the content of the at least one thermoplastic elastomer in the composition of the second layer is within a range extending from 5 to 45 phr.

44. The elastomeric laminate according to claim 43, wherein the content of the at least one thermoplastic elastomer in the composition of the second layer is within a range extending from 10 to 40 phr.

45. The elastomeric laminate according to claim 27, wherein the at least one diene elastomer of the second layer is selected from the group consisting of essentially unsaturated diene elastomers and mixtures thereof.

46. The elastomeric laminate according to claim 45, wherein the at least one diene elastomer is selected from the group consisting of homopolymers obtained by polymerization of a conjugated diene monomer having from 4 to 12 carbon atoms, copolymers obtained by copolymerization of one or more conjugated dienes with one another or with one or more vinylaromatic compounds having from 8 to 20 carbon atoms, and mixtures thereof.

47. The elastomeric laminate according to claim 46, wherein the at least one diene elastomer is selected from the group consisting of polybutadienes, synthetic polyisoprenes, natural rubber, butadiene copolymers, isoprene copolymers and mixtures thereof.

48. The elastomeric laminate according to claim 27, wherein the second layer comprises a reinforcing filler.

49. The elastomeric laminate according to claim 48, wherein the reinforcing filler is carbon black and/or silica.

50. The elastomeric laminate according to claim 49, wherein the predominant reinforcing filler is a carbon black.

51. A tire comprising a laminate according to claim 27.

52. A pneumatic object comprising a laminate according to claim 27.
